(19) United States
(12) Patent Application Publication
(10) Pub. No.: US 2024/0406340 A1
(43) Pub. Date: Dec. 5, 2024

(54) METHOD AND APPARATUS FOR PROCESSING IMAGE, AND STORAGE MEDIUM

(71) Applicant: BOE Technology Group Co., Ltd., Beijing (CN)

(72) Inventor: Xitong MA, Beijing (CN)

(21) Appl. No.: 18/802,071

(22) Filed: Aug. 13, 2024

Related U.S. Application Data
(63) Continuation-in-part of application No. 17/781,175, filed on May 31, 2022, now Pat. No. 12,096,151.

(30) Foreign Application Priority Data
May 27, 2020 (CN) 202010464219.2

(51) Int. Cl. H04N 5/265; G06F 3/14

(52) U.S. Cl. CPC H04N 5/265; G06F 3/14

(57) ABSTRACT

Disclosed is a method for processing an image. The method is applicable to a field programmable gate array (FPGA), and includes: acquiring at least one channel of video data of an ultra-high-definition (UHD) video system; generating oscillogram data based on each channel of the video data; acquiring a pre-generated background image of an oscillogram; and generating the oscillogram based on the background image and the oscillogram data.

### CROSS-REFERENCE TO RELATED APPLICATION

This application is a continuation-in-part application of U.S. patent application Ser. No. 17/781,175, filed on May 31, 2022, which is a 371 of PCT Application No. PCT/CN2021/096040, filed on May 26, 2021, claims priority to Chinese patent application No. 202010464219.2, filed on May 27, 2020, and entitled “METHOD AND APPARATUS FOR DRAWING VECTOR DIAGRAM BASED ON 8K VIDEO SYSTEM AND STORAGE MEDIUM”, all of which are hereby incorporated by reference in their entireties for all purposes.

### TECHNICAL FIELD

The present disclosure relates to the field of data processing technologies, and in particular relates to a method and apparatus for processing an image, and a storage medium.

### BACKGROUND

For an ultra-high-definition (UHD) video system, for example, an 8 k video system, parameters such as color, brightness, and contrast of an image of a video system are needed to analyze and display by an oscillogram, to perform color calibration, brightness adjustment, and the like of the image.

### SUMMARY

Embodiments of the present disclosure provide a method and apparatus for processing an image, and a storage medium.

The embodiments of the present disclosure provide a method for processing an image. The method is applicable to a field programmable gate array (FPGA) and includes: acquiring at least one channel of video data of an ultra-high-definition (UHD) video system; generating oscillogram data based on each channel of the video data; acquiring a pre-generated background image of an oscillogram; and generating the oscillogram based on the background image and the oscillogram data.

In some embodiments, the method further includes: acquiring at least one channel of superimposed video data by superimposing each channel of the video data with corresponding oscillogram data; and wherein the generating the oscillogram based on the background image and the oscillogram data includes: acquiring at least one channel of video data with an oscillogram by fusing the at least one channel of superimposed video data with the background image.

In some embodiments, acquiring at least one channel of video data of the UHD video system includes: acquiring at least two channels of video data of the UHD video system; and acquiring at least one channel of video data with the oscillogram by fusing the at least one channel of superimposed video data with the background image includes: acquiring at least two channels of video data with the oscillogram by fusing each channel of the superimposed video data with the background image.

In some embodiments, the method further includes: outputting the at least two channels of video data with the oscillogram, to cause a display device to display the at least two channels of video data with the oscillogram, wherein a display region of the display device includes at least two subdisplay regions, each of the at least two subdisplay regions displaying one channel of video data with the oscillogram.

In some embodiments, the oscillogram data includes at least one of vector diagram data, histogram data, and waveform diagram data.

In some embodiments, the oscillogram includes a first oscillogram and a second oscillogram that are different types; and the background image includes a plurality of regions arranged in an array, each of the plurality of regions includes a first subregion and a second subregion, the first subregion of each of the plurality of regions is a background image of the first oscillogram, and the second subregion of each of the plurality of regions is a background image of the second oscillogram.

In some embodiments, the background image is pre-stored in a system on chip (SoC), and acquiring the pre-generated background image of the oscillogram includes: receiving the background image from the SoC.

In some embodiments, generating oscillogram data based on each channel of the video data includes: counting oscillogram data of each frame image in each channel of the video data by regional counting.

In some embodiment, counting oscillogram data of each frame image in each channel of the video data by regional counting includes: regionally counting the oscillogram data of each frame image in each channel of the video data by using a dual-port random access memory (RAM) and a RAM ping-pong operation mechanism.

In some embodiments, regionally counting the oscillogram data of each frame image in each channel of the video data by using the dual-port RAM and the RAM ping-pong operation mechanism includes: determining, for each channel of the video data, a number of dual-port RAMs required according to a number of regions, wherein the number of dual-port RAMs required is twice the number of regions; dividing the dual-port RAMs required into two groups; and regionally counting the oscillogram data of each frame image in the video data by using the RAM ping-pong operation mechanism and two groups of dual-port RAMs, wherein one group of dual-port RAMs in the two groups of dual-port RAMs are configured to regionally count oscillogram data of an odd-numbered frame image in the video data, and the other group of dual-port RAMs in the two groups of dual-port RAMs are configured to regionally count oscillogram data of an even-numbered frame image in the video data.

In some embodiments, the regionally counting the oscillogram data of each frame image in the video data by using the RAM ping-pong operation mechanism and the two groups of dual-port RAMs includes the following two steps alternately: regionally counting the oscillogram data of the odd-numbered frame image by using a first group of dual-port RAMs; and regionally counting the oscillogram data of the even-numbered frame image by using a second group of dual-port RAMs: wherein 0 is written into write ports of the second group of dual-port RAMs in response to write ports of the first group of dual-port RAMs regionally counting the oscillogram data of the odd-numbered frame image, and 0 is written into the write ports of the first group of dual-port RAMs in response to the write ports of the second group of dual-port RAMs regionally counting the oscillogram data of the even-numbered frame image; and read ports of the second group of dual-port RAMs do not perform any operation in response to read ports of the first group of dual-port RAMs reading the oscillogram data of the odd-numbered frame image, and the read ports of the first group of dual-port RAMs do not perform any operation in response to the read ports of the second group of dual-port RAMs reading the oscillogram data of the even-numbered frame image.

In some embodiments, the UHD video system is a 4 k-resolution video system, a 6 k-resolution video system, an 8 k-resolution video system, or a 12 k-resolution video system.

The embodiments of the present disclosure provide an apparatus for processing an image. The apparatus includes a field programmable gate array (FPGA), wherein the FPGA is configured to acquire at least one channel of video data of an ultra-high-definition (UHD) video system; generate oscillogram data based on each channel of the video data; acquire a pre-generated background image of an oscillogram; and generate the oscillogram based on the background image and the oscillogram data.

In some embodiments, the FPGA is configured to acquire at least one channel of superimposed video data by superimposing each channel of the video data with corresponding oscillogram data; and acquire at least one channel of video data with an oscillogram by fusing the at least one channel of superimposed video data with the background image.

In some embodiments, the FPGA is configured to acquire at least two channels of video data of the UHD video system; and acquire at least two channels of video data with the oscillogram by fusing each channel of the superimposed video data with the background image.

In some embodiment, the FPGA is configured to output the at least two channels of video data with the oscillogram; and the apparatus further includes a display device configured to display the at least two channels of video data with the oscillogram, wherein a display region of the display device includes at least two subdisplay regions, each of the at least two subdisplay regions displaying one channel of video data with the oscillogram.

In some embodiments, the oscillogram data includes at least one of vector diagram data, histogram data, and waveform diagram data.

In some embodiments, the oscillogram includes a first oscillogram and a second oscillogram that are different types; and the background image includes a plurality of regions arranged in an array, each of the plurality of regions includes a first subregion and a second subregion, the first subregion of each of the plurality of regions is a background image of the first oscillogram, and the second subregion of each of the plurality of regions is a background image of the second oscillogram.

In some embodiments, the apparatus further includes a system on chip (SoC), wherein the SOC is configured to generate the background image.

In some embodiments, the UHD video system is a 4 k-resolution video system, a 6 k-resolution video system, an 8 k-resolution video system, or a 12 k-resolution video system.

The embodiments of the present disclosure provide a non-transitory computer-readable storage medium storing a computer program, wherein the computer program, when executed by a processor, causes the processor to perform any one of the methods described above.

### BRIEF DESCRIPTION OF THE DRAWINGS

To describe the technical solutions in the embodiments of the present disclosure more clearly, the following briefly introduces the accompanying drawings of the embodiments. Apparently, the accompanying drawings in the following descriptions only relate to some embodiments of the present disclosure, but are not intended to limit the present disclosure.

FIG. 1 is a schematic flowchart of a method for processing an image according to some embodiments of the present disclosure;

FIG. 2 is a schematic flowchart of a method for processing an image based on an 8 k video system according to some embodiments of the present disclosure;

FIG. 3A is a distribution schematic diagram of a display region in a four-split screen mode according to some embodiments of the present disclosure;

FIG. 3B is another distribution schematic diagram of a display region in a four-split screen mode according to some embodiments of the present disclosure;

FIG. 4 is a schematic diagram of a vector diagram according to some embodiments of the present disclosure;

FIG. 5 is a schematic diagram of a histogram according to some embodiments of the present disclosure;

FIG. 6 is a schematic diagram of a waveform diagram according to some embodiments of the present disclosure;

FIG. 7 is a schematic diagram of counting of vector diagram data according to some embodiments of the present disclosure;

FIG. 8 is a schematic diagram of a random access memory (RAM) ping-pong operation mechanism according to some embodiments of the present disclosure;

FIG. 9 is a display schematic diagram of superimposed video data according to some embodiments of the present disclosure;

FIG. 10 is a schematic diagram of a background image of an oscillogram according to some embodiments of the present disclosure;

FIG. 11 is a display schematic diagram of video data with an oscillogram according to some embodiments of the present disclosure;

FIG. 12 is a schematic flowchart of a method for processing an image according to some embodiments of the present disclosure;

FIG. 13 is a schematic structural diagram of an apparatus for processing an image according to some embodiments of the present disclosure; and

FIG. 14 is a schematic structural diagram of an apparatus for processing an image according to some embodiments of the present disclosure.

### DETAILED DESCRIPTION

For clearer descriptions of the objectives, technical solutions, and advantages of the present disclosure, the technical solutions of the embodiments of the present disclosure are described clearly and completely with reference to the accompanying drawings in the embodiments of the present disclosure. Apparently, the described embodiments are merely a part of the embodiments of the present disclosure, rather than all of the embodiments. According to the described embodiments of the present disclosure, all of the other embodiments obtained by a person of ordinary skill in the art without any creative efforts shall fall within the protection scope of the present disclosure.

Unless otherwise defined, technical terms or scientific terms used in the present disclosure shall be taken to mean the ordinary meanings as understood by those of ordinary skill in the art to which the present disclosure belongs. The terms “first,” “second,” and the like used in the present disclosure do not denote any order, quantity, or importance, but are merely used to distinguish different components. Similarly, the term “a,” “an,” “the,” or the like is not intended to limit the number, but to denote the number of at least one. The term “comprise,” “include,” or the like is intended to mean that the elements or objects before the term cover the elements or objects or equivalents listed after the term, without excluding other elements or objects.

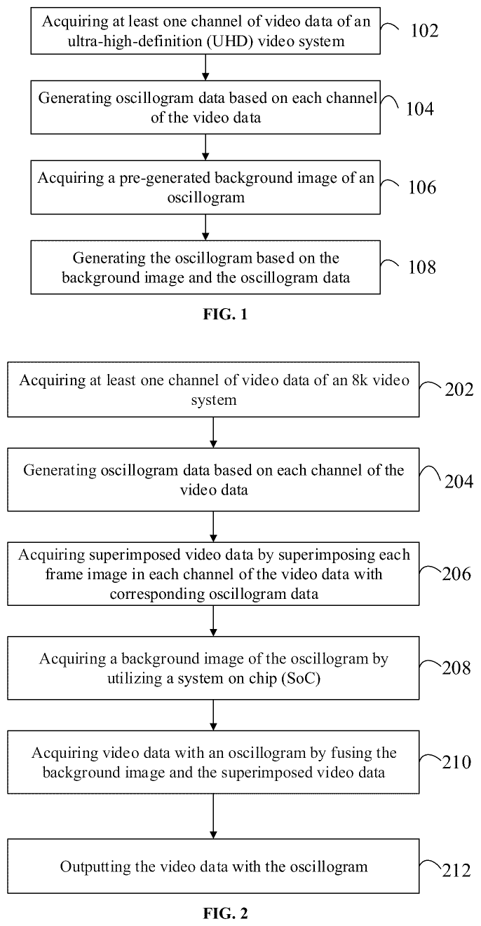

Embodiments of the present disclosure provide a method for processing an image. FIG. 1 is a schematic flowchart of a method for processing an image according to the embodiment of the present disclosure. The method may be implemented by a field programmable gate array (FPGA). As shown in FIG. 1, the method includes the following steps.

In step 102, at least one channel of video data of an ultra-high-definition (UHD) video system is acquired.

In step 102, each channel of the video data includes a plurality of frames of images.

In step 104, oscillogram data is generated based on each channel of the video data.

In step 104, corresponding oscillogram data is generated for each frame image of each channel of the video data.

In step 106, a pre-generated background image of an oscillogram is acquired.

Exemplarily, the background image is pre-generated before the method shown in FIG. 1 is performed. For example, the background image may be generated and stored in advance by a system on chip (SoC). Step 106 may include receiving a background image from an SoC.

In step 108, the oscillogram is generated based on the background image and the oscillogram data.

Exemplarily, the oscillogram corresponding to each frame image can be acquired by fusing the background image with the oscillogram data corresponding to each frame image.

In the embodiments of the present embodiment, the pre-generated background image is acquired and the oscillogram data of the video data is generated by using the FPGA, and then the oscillogram is generated based on the background image and the oscillogram data, thus providing an effective method for drawing a oscillogram of UHD video data, which can fully improve the efficiency in generating the oscillogram of the UHD video data by using the FPGA.

In some embodiments, the step 108 may include: acquiring video data with an oscillogram by fusing the background image, each frame image in the video data, and the corresponding oscillogram data.

In some embodiments of the present disclosure, the UHD video system includes but is not limited to a 4 k video system, a 6 k video system, an 8 k video system, a 12 k video system, and the like.

The 4 k video system means that the resolution of each frame image in the corresponding video data is 4 k (3,840×2,160). The 6 k video system means that the resolution of each frame image in the corresponding video data is 6 k (5,760×3,240). The 8 k video system means that the resolution of each frame image in the corresponding video data is 8 k (7,680×4,320). The 12 k video system means that the resolution of each frame image in the corresponding video data is 12 k (11,520×6,480) . . .

The present embodiment will be described in detail below by taking the 8 k video system as an example. It should be noted that the method provided by the present embodiment is also applicable to UHD video systems with other resolutions.

FIG. 2 is a schematic flowchart of a method for processing an image based on an 8 k video system according to some embodiments of the present disclosure. The method may be implemented by a field programmable gate array (FPGA). As shown in FIG. 2, the method includes the following steps.

In step 202, at least one channel of video data of an 8 k video system is acquired.

Optionally, the 8 k video system is applied to a professional UHD monitor system, so as to provide a UHD monitoring screen for a professional monitor.

In some embodiments, the step 202 includes: acquiring at least two channels of video data of the 8 k video system. In some scenarios, a split-screen mode is required to display a plurality of channels of video data simultaneously, and thus, it is necessary to acquire at least two channels of video data simultaneously. Here, the split-screen mode refers to displaying one channel of video data in different subdisplay regions in the display region of the same display device.

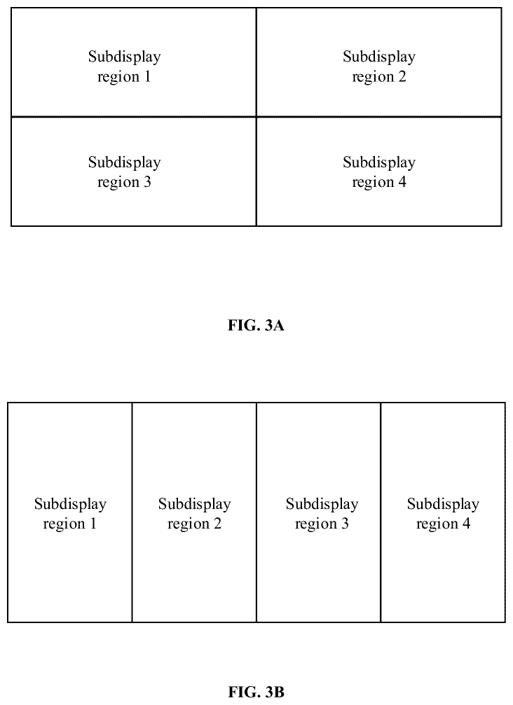

FIG. 3A is a distribution schematic diagram of a display region in a four-split screen mode according to some embodiments of the present disclosure, and FIG. 3B is another distribution schematic diagram of a display region in a four-split screen mode according to some embodiments of the present disclosure. As shown in FIG. 3A and 3B, a display region of a display device is divided into four subdisplay regions, e.g. subdisplay region 1, subdisplay region 2, subdisplay region 3, and subdisplay region 4, and four channels of video data are displayed in the four subdisplay regions, respectively. In FIG. 3A, the four sub-display regions are arranged in a matrix. In FIG. 3B, the four sub-display regions are arranged in a row.

It should be noted that the number of split screens is not limited in the embodiments of the present disclosure, for example, it may also be three-split screens, six-split screens, eight-split screens, and the like. In addition, the arrangement of the subdisplay regions is also not limited in the present disclosure embodiments, which can be set according to actual needs. For example, for the three-split screen mode, the three subdisplay regions may be arranged in a zigzag pattern; for example, for the six-split screen mode, the six subdisplay regions may be arranged in a matrix, or arranged in two rows, with two neighboring rows of subdisplay regions staggered in the row direction, and the like.

In step 204, oscillogram data is generated based on each channel of the video data.

In step 204, the FPGA can count real-time oscillogram data for each channel of the video data.

In the embodiments of the present disclosure, the video data is a video stream, and each channel of video data contains frame images arranged in sequence. For each frame image in each channel of the video data, the oscillogram data is counted.

A color image may be described by three channels of red, green, and blue, or by three channels consisting of one luminance and two chromaticities. The former is the RGB color space and the latter is the YUV color space.

Optionally, before counting the oscillogram data, it is necessary to convert image data represented by the three channels RGB in the RGB color space into image data represented by the three channels Y, Cr, and Cb in the YUV color space.

In one or more embodiments of the present disclosure, counting the oscillogram data of each frame image in each channel of the video data includes: counting the oscillogram data of each frame image in each channel of the video data by regional counting.

By regionally counting the oscillogram data, on the one hand, the parallel processing capability of the FPGA is fully utilized, on the other hand, the processing speed can be greatly improved.

In the embodiments of the present disclosure, the resolution of one single frame of each channel of the video data is determined by the resolution of the HD video system and the number of splits on a screen. For example, for an 8 k video system, the number of split screens is four, and the resolution of one single frame of each channel of the video data is 4 k. For another example, for a 4 k video system, the number of split screens is four, and the resolution of one single frame of each channel of the video data is 2 k.

In one or more embodiments of the present disclosure, counting the oscillogram data of each frame image in each channel of the video data by regional counting includes: regionally counting the oscillogram data of each frame image in each channel of the video data by using a dual-port random access memory (RAM) and a RAM ping-pong operation mechanism.

The dual-port RAM is a shared multi-port memory which has two sets of completely independent data lines, address lines, and read-write control lines on one static random-access memory (SRAM) and allows two independent systems to access the memory randomly at the same time. The dual-port RAM has the biggest feature of storage data sharing. One memory is equipped with two sets of independent address lines, data lines, and control lines, allowing two independent central processing units (CPUs) or controllers to access a memory unit asynchronously. Due to data sharing, it needs to have access to arbitration control. The internal arbitration logic control provides the following functions: timing control of access to the same address unit; allocation of access permission to data blocks of the memory unit; signaling logic (for example, interrupt signal), and the like. The dual-port RAM may be configured to improve the throughput of RAM and is suitable for real-time data caching.

In this step, the reading and writing efficiency can be improved by using the RAM ping-pong operation mechanism, that is, reading data in RAM 2 in response to writing in RAM 1, and reading data in RAM 1 in response to writing in RAM 2.

In one or more embodiments of the present disclosure, regionally counting the oscillogram data of each frame image in each channel of the video data by using the dual-port RAM and the RAM ping-pong operation mechanism includes:

determining, for each channel of the video data, the number of dual-port RAMs required according to the number of regions, wherein the number of dual-port RAMs required is twice the number of regions; dividing the dual-port RAMs required into two groups; regionally counting the oscillogram data of each frame image in the channel of the video data by using the RAM ping-pong operation mechanism and two groups of dual-port RAMs, wherein one group of dual-port RAMs in the two groups of dual-port RAMs are configured to regionally count oscillogram data of an odd-numbered frame image in the channel of the video data, and the other group of dual-port RAMs in the two groups of dual-port RAMs are configured to regionally count oscillogram data of an even-numbered frame image in the channel of the video data.

In the embodiment that adopts the regional counting method, for each regional image. the oscillogram data may be counted by using one dual-port RAM. Therefore, for one frame image, a corresponding number of RAMs are required for processing according to the number of regions. In the embodiment that adopts the RAM ping-pong operation mechanism, since an odd-numbered frame image and an even-numbered frame image need different RAMs for counting, two groups of RAMs need to operate at the same time, that is, reading data in a second group of RAMs in response to writing a first group of RAMs and reading data in the first group of RAMs in response to writing the second group of RAMs.

Optionally, the oscillogram includes at least one of vector diagram, histogram, and waveform diagram. The three oscillograms are described below.

The vector diagram is mainly used to display and analyze parameters such as color, brightness, and contrast of an image. It can help related personnel to understand more accurately the color distribution and variation of an image, so as to carry out precise image processing and adjustment.

The vector diagram is constructed based on the YUV color space. In digital systems, the three channels of the YUV color space are often referred to as Y, Cr, and Cb, wherein the r subscript represents that the U channel is computed by subtracting the red RGB signal from the Y luminance signal, and the b subscript represents that the V channel is computed by subtracting the blue RGB signal from the Y luminance signal, which is broadly averaged R, G, and B.

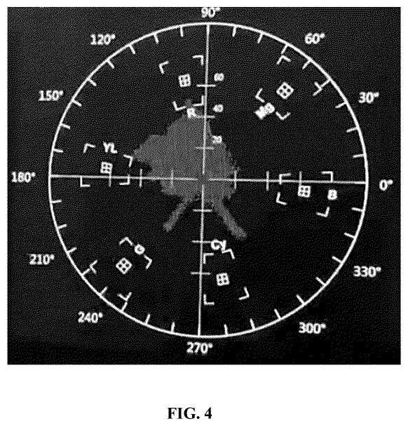

FIG. 4 is a schematic diagram of a vector diagram according to some embodiments of the present disclosure. Referring to FIG. 4, the gray color block in the middle is vector diagram information. The vector diagram is a graph of the horizontal and vertical coordinates of the U and V signals, with the U signal being vertical and the V signal being horizontal, resulting in a display that is a color wheel of one hue, with red at or near the top. The more saturated the color, the greater the deviation of the U and V signals, the closer the display will be to the edges of the vector diagram disk, and a completely unsaturated color will be displayed as a dot in the center.

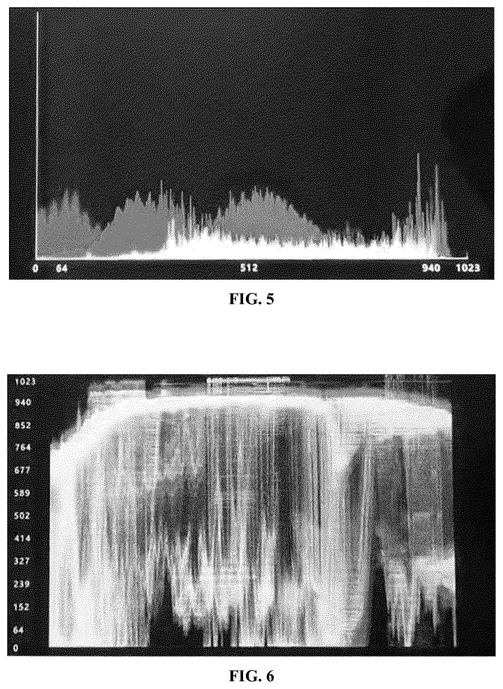

The histogram is mainly used to evaluate the exposure of an image. Through the histogram, the relevant person can quickly understand the brightness distribution of an image and determine whether the image is overexposed or underexposed, so as to make adjustments accordingly. FIG. 5 is a schematic diagram of a histogram according to some embodiments of the present disclosure. Referring to FIG. 5, the horizontal coordinate indicates a grayscale value, and the vertical coordinate indicates the number of pixels. The histogram is used to display the number of pixels corresponding to each gray scale value in a corresponding frame of the image.

The waveform diagram is a graphical representation of a camera's exposure, white balance, and other parameters in the form of a waveform, which typically uses horizontally oriented lines to represent changes in the camera's parameters. FIG. 6 is a schematic diagram of a waveform diagram according to some embodiments of the present disclosure.

The counting process for each type of oscillogram data is described below.

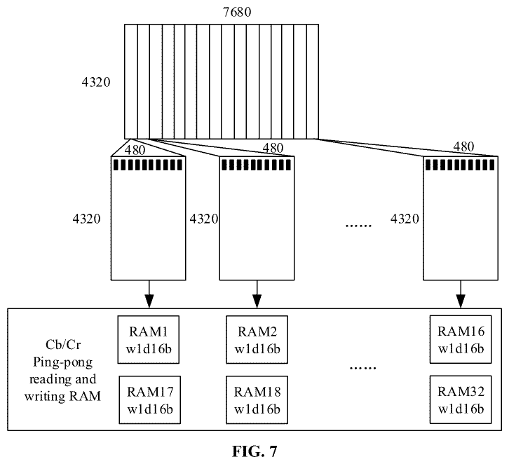

Referring to FIG. 7, assuming a frame image with a resolution of 7680×4320 (i.e., 8 k), the counting process of the oscillogram data mainly includes the following steps.
a) Inputting data: 480*4,320*16@148.5 MHz, in which 16 is the number of regions, 480*4,320 is the resolution of each region, and 148.5 MHz is the clock frequency. Exemplarily. the clock frequency corresponds to a code stream of the video data, for example, for the video data with a code stream of 2.97 Gb/s, the clock frequency is 148.5 MHz.
b) Counting data: 480*4,320*16@148.5 MHz, all 8 K pixels being traversed.
c) Regionally counting oscillogram data of each frame image:

For vector diagram data:

the RAM in the RAM ping-pong operation mechanism has a width of 1 bit and a depth of 16 bits, and a total number of 16*2=32 RAMs are required for the ping-pong operation;
wherein the width of the RAM is configured to store data Cb/Cr, is set to 1 in response to having a value, and is set to 0 in response to having no value, and the depth of the RAM is 16 bits, of which 8 bits represent 256 positions of the vertical ordinate Cr in the vector diagram and 8 bits represent 256 positions of the horizontal coordinate Cb in the vector diagram;
writing operation: RAMs 1-16 use the high 8 bits of the pixel Cb/Cr value (the pixel Cb/Cr value is 10 bits, but a RAM address may only store 8 bits, thus the high 8 bits of the pixel Cb/Cr values are selected) as the addresses of RAM, and the addressing is set to 1;
reading operation: RAMs 17-32 use the high 8 bits of the pixel Cb/Cr value as the addresses of RAM, and delay one beat to complete the reading operation.

For histogram data:

The RAM has a depth of 10 bits, representing the gray scale value (i.e., the value of Y); and a width of 16 bits, representing the number of pixels corresponding to each gray scale value. For waveform diagram data:

The RAM has a depth of 13 bits, representing the horizontal position of each frame image in the video data; and a width of 16 bits, representing the distribution of gray levels under each position.

In one or more embodiments of the present disclosure, regionally counting the oscillogram data of each frame image in the video data by using the RAM ping-pong operation mechanism and the two groups of dual-port RAMs includes the following two steps alternately: regionally counting the oscillogram data of the odd-numbered frame image by using a first group of dual-port RAMs, and regionally counting the oscillogram data of the even-numbered frame image by using a second group of dual-port RAMs.

0 is written into the write ports of the second group of dual-port RAMs in response to write ports of the first group of dual-port RAMs regionally counting the oscillogram data of the odd-numbered frame image, and 0 is written into the write ports of the first group of dual-port RAMs in response to the write ports of the second group of dual-port RAMs regionally counting the oscillogram data of the even-numbered frame image, and read ports of the second group of dual-port RAMs do not perform any operation in response to read ports of the first group of dual-port RAMs reading the oscillogram data of the odd-numbered frame image, and the read ports of the first group of dual-port RAMs do not perform any operation in response to the read ports of the second group of dual-port RAMs reading the oscillogram data of the even-numbered frame image.

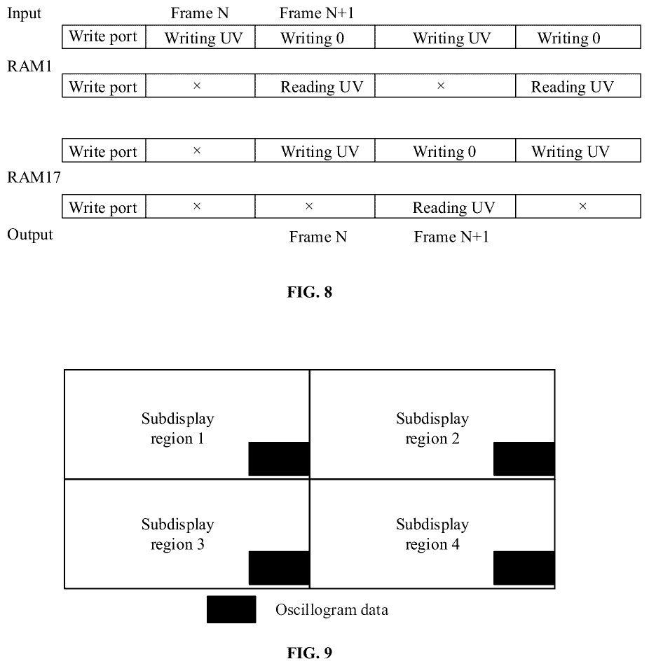

FIG. 8 shows one embodiment of the RAM ping-pong operation mechanism.

By taking an input image divided into 16 regions as an example (referring to FIG. 7), a total number of 32 dual-port RAMs are required, and Frame N (for example, an odd-numbered frame) operates the first group of RAMs (RAMs 1-16); Frame N+1 (for example, an even-numbered frame) operates the second group of RAMs (RAMs 17-32). The specific operation of the RAM ping-pong operation mechanism is described below.

In response to inputting data of Frame N, the write port of RAM 1 forms a 16-bit address by the high 8 bits of a UV address, and writes first data of Frame N by using the 16-bit address as a writing address of RAM 1, with the organization form [U[9:2], V[9:2]], and the read port of RAM 1 does not perform any operation.

In response to inputting data of Frame N, the write port of RAM 17 does not perform any operation, and the read port of RAM 17 does not perform any operation, either.

In response to inputting data of Frame N+1, the write port of RAM 1 writes 0 according to the timing of 1,024*1,024, and the read port of RAM 1 reads data according to the timing of 1,024*1,024.

In response to inputting data of Frame N+1, the write port of RAM 17 forms a 16-bit address by the high 8 bits of the UV address and writes first data of Frame N+1 by using the 16-bit address as the writing address of RAM 1, with the organization form [U[9:2], V[9:2]], and the read port of RAM 17 does not perform any operation.

9:2 represents the high 8 bits of 10 bits, that is, the 9^{th} bit to the 2^{nd} bit.

The operation modes of RAMs 2-16 are the same as that of RAM 1. The operation modes of RAMs 18-32 are the same as that of RAM 17.

In the above-mentioned embodiments, by real-time calculation of counting data using ping-pong operation of the dual-port RAM, two implementations of 100% and 75% of the vector diagram can be realized. 100% and 75% are two indicators of the vector diagram, referring to the length of a statistical result relative to the center point. At 75%, all the largest colors of red, yellow, green, cyan, blue, and pinkish red fall on the matts in FIG. 3A or FIG. 3B. for calibrating whether the colors are correct or not. 100% is the actual length of the above colors, not exceeding the circle in FIG. 3. Therefore, 75% is more valuable for reference, but ordinary monitors have both two options.

In step 206, superimposed video data is acquired by superimposing each frame image in each channel of the video data with corresponding oscillogram data.

Exemplarily, the oscillogram data is superimposed on a corresponding frame image, e.g., at a localized location such as a lower-right corner, an upper-left corner, etc., of the frame. In some examples, the location of the superimposition of the oscillogram data may be determined according to a position setting instruction. In other examples, the superimposed position of the oscillogram data may be a default position.

FIG. 9 is a display schematic diagram of superimposed video data according to some embodiments of the present disclosure. As shown in FIG. 9, the oscillogram data is superimposed in the lower-right corner of each frame image.

Optionally, the superimposed video data may be written to a double data rate synchronous dynamic random access memory (DDR SDRAM) of the FPGA for subsequent processing.

Exemplarily, for any frame image in each channel of the video data, each frame image is superimposed with the corresponding oscillogram data using the following processes:

In the case that the oscillogram data corresponding to a pixel point in the oscillogram region is equal to 0, the oscillogram data for the pixel point is set to transparent (i.e., replaced with the video data for the corresponding pixel point), or semi-transparent (i.e., the luminance value of the video data for the corresponding pixel point is halved, and the Cr and Cb values remain unchanged), or opaque (i.e., the video data for that pixel point is set to black).

In the case that the oscillogram data corresponding to a pixel point in the oscillogram region is greater than 0, the oscillogram data is used as the Y value of the corresponding pixel point, and signals such as gray or green are used as the Cr and Ch values of the corresponding pixel point.

Here, the oscillogram region is a portion of a region of the subdisplay region for displaying the oscillogram.

In step 208, a background image of the oscillogram is acquired by utilizing a system on chip (SoC).

In this step, the SoC is used to acquire the background image of the oscillogram.

In the embodiments of the present disclosure, the counting of the oscillogram data is obtained by FPGA, but FPGA is suitable for doing high-speed arithmetic and is not suitable for being in charge of graphics, while SOC is suitable for doing the work of graphic drawing, therefore, the SoC is used to draw the background image in this step.

Optionally, referring to FIG. 4, the white wireframe in FIG. 4 is the background image of the vector diagram. As shown in FIG. 3A and FIG. 3B, the background image of the vector diagram mainly provides a reference standard for the vector diagram. In general, for each vector diagram, the background image is the same. Referring to FIG. 5, the coordinate system in FIG. 5 is the background image of the histogram. The background image of the histogram mainly provides the reference standard for the histogram. In general, for each histogram, the background image is the same. Referring to FIG. 6, the coordinate system in FIG. 6 is the background image of the waveform diagram. The background image of the waveform diagram mainly provides the reference standard for the waveform diagram. In general, for each waveform diagram, the background image is the same.

Optionally, the information of the background image may be written to the SOC in advance by way of programming, and after power-up initialization of the 8 k video system, the background image is sent to the FPGA via the SOC, and the FPGA receives the background image and stores it in the DDR within the FPGA. Optionally, during the power-up startup process, the FPGA distinguishes the background image transmitted by the SOC through a handshake signal between the SOC and the FPGA. Exemplarily, the handshake signal carries indication information which is used to indicate that the subsequently transmitted image is the background image of the oscillogram. After the transmission of the background image is complete, the FPGA may utilize the transmission channel to transmit other data, such as a user interface.

In one possible implementation, the background image of each type of the oscillogram is one single image. The FPGA needs to acquire the background image of each type of the oscillogram. For example, in the case that the oscillogram includes three types of oscillograms: vector diagram, histogram, and waveform diagram, the FPGA needs to obtain three background images from the SoC, that is a background image of the vector diagram, a background image of the histogram, and a background image of the waveform diagram.

In another possible implementation, the background images of the multiple oscillograms are combined into a single image. The FPGA only needs to obtain a single image from the SoC to obtain the background images of the multiple oscillograms. Thus, in the case where multiple types of oscillograms need to be displayed, the background images of the oscillograms can be read by only one read controller, thereby reducing the bandwidth requirement for displaying multiple types of oscillograms.

For example, the oscillogram includes a first oscillogram and a second oscillogram, the first oscillogram and the second oscillogram are of different types. The background image of the oscillogram includes a plurality of regions arranged in an array, each region includes a first subregion and a second subregion, the first sub-region of each region is a background image of the first oscillogram, and the second sub-region of each region is a background image of the second oscillogram.

Optionally, the first oscillogram and the second oscillogram may be any two of the aforementioned vector diagram, histogram, and waveform diagram.

For example, in addition to the first oscillogram and the second oscillogram, the oscillogram includes a third oscillogram, the third oscillogram is of a different type than the first oscillogram and the second oscillogram. Each region also includes a third sub-region, and the third sub-region of each region is a background image of the third oscillogram.

Optionally, the first oscillogram, the second oscillogram, and the third oscillogram may be a vector diagram, a histogram, and a waveform diagram, respectively, as described previously.

Optionally, each region may also include a free subregion that may be reserved for background images of other types of oscillograms.

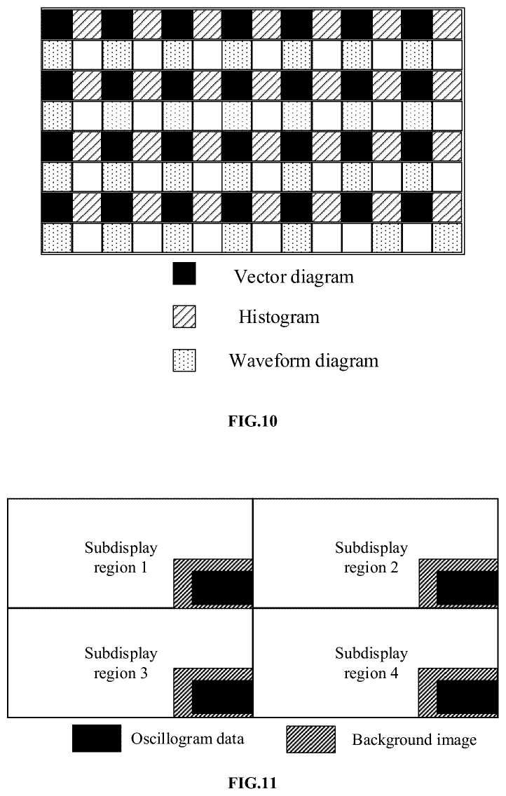

FIG. 10 is a schematic diagram of a background image of an oscillogram according to some embodiments of the present disclosure. As shown in FIG. 10, each region includes four subregions corresponding to the background image of the vector diagram, the background image of the histogram, the background image of the waveform diagram, and the free subregion, respectively.

In step 210, video data with an oscillogram is acquired by fusing the background image and the superimposed video data.

Optionally, the background image is written to the DDR of the FPGA for storage after power-up initialization, and the superimposed video data is also stored in the DDR of the FPGA. when it is necessary to carry out the fusion of the three, the superimposed video data and the corresponding background image are read from the DDR and superimposed, so as to complete the complete fusion of the oscillogram data, the background image, and the video data on the output side of the DDR.

In one possible embodiment, the background image of the oscillogram stored in the DDR is a background image obtained by combining the background image of the vector diagram, the background image of the histogram, and the background image of the waveform diagram, and only a portion of the type of the oscillogram needs to be displayed in the video data to be displayed. In this case, the background image of the desired type of oscillogram can be read from the DDR, and then the read background image is fused with the superimposed video data.

For example, in the case that only the vector diagram needs to be displayed in the video data to be displayed, the background image of the vector diagram is read from the DDR, and then the read background image is fused with the superimposed video data.

Exemplarily, for any frame image in the superimposed video data, the background image and the superimposed video data are superimposed in the following way.

In the case that the data of the background image corresponding to a pixel in the oscillogram region is equal to 0, the data of the background image corresponding to the pixel is set to be transparent (that is, replaced with the video data of the corresponding pixel), or translucent (that is, the luminance value of the video data of the corresponding pixel is halved, and Cr and Cb values are unchanged), or opaque (that is, the video data of the corresponding pixel is set to be black).

In the case that the data of the background image corresponding to the pixel in the oscillogram region is greater than 0, the video data of the corresponding pixel point is replaced with the data of the background image.

In step 212, the video data with the oscillogram is output.

In step 212, the number of channels of the output video data with the oscillogram is equal to the number of channels of the video data acquired in step 202.

In the case that at least two channels of video data are acquired in step 202, the at least two channels of video data with an oscillogram are correspondingly output in the step 212 to cause the display device to display the at least two channels of video data with the oscillogram. The display region of the display includes at least two subdisplay regions, each subdisplay region displays one channel of video data with an oscillogram.

Optionally, the display device may be an independent display device or a display panel integrated into the same device as the aforementioned FPGA.

FIG. 11 is a display schematic diagram of video data with an oscillogram according to some embodiments of the present disclosure. As shown in FIG. 11, the display device has four subdisplay regions, and an oscillogram is displayed in the lower-right corner of each subdisplay region, which is formed by superimposing the oscillogram data and a corresponding background image.

In one possible implementation, the oscillogram data, the background image of the oscillogram, and the video data may be in different layers, thereby stacking the three together. For example, the video data serves as layer one, the background image serves as layer two, and the oscillogram data serves as layer three, wherein layer three is the topmost layer.

In one possible implementation, the oscillograms corresponding to various channels of the video data are of the same type, and accordingly, the oscillograms displayed in each of the sub-display regions are of the same type. For example, the oscillograms displayed in all of the sub-display regions are vector diagrams.

In another possible embodiment, there exist at least two channels of video data corresponding to different types of oscillograms, and accordingly, there exist at least two sub-display regions displaying different types of oscillograms. In this way, the types of the oscillograms corresponding to each channel of video data can be flexibly selected as needed.

In some examples, a plurality of subdisplay regions of the display are arranged in a plurality of rows, each row of subdisplay regions includes at least two subdisplay regions, each row of subdisplay regions displays the same type of the oscillograms, and two neighboring rows of subdisplay regions display different types of the oscillograms. For example, in FIG. 11, the oscillograms displayed in the first row of subdisplay regions are all vector diagrams, and the oscillograms displayed in the second row of subdisplay regions are histograms.

As the time difference of displaying the oscillograms in the plurality of subdisplay regions in the same row of subdisplay regions is small, in the case that the types of the oscillograms displayed in each row of subdisplay regions are the same, the background image of the oscillograms can be read only once to be fused with the images in the multiplexed superimposed video data corresponding to the subdisplay regions in the same row, which is conducive to reducing the number of times that the background image is read.

Optionally, sending to a display may be realized by V-by-One for outputting the video data with the oscillogram. V-by-One is a digital interface standard specially developed for image transmission. A low voltage differential signal (LVDS) is used as the input and output level of a signal, and the signal frequency of a board card is about 1 GHz. Compared with a complementary metal oxide semiconductor/transistor-transistor logic (CMOS/TTL) mode, this method can reduce the number of transmission lines to about 1/10 of the previous.

It can be seen from the above embodiments that the method for processing the image based on the 8 k video system according to the present disclosure draws the background image by using the SoC, then generates the oscillogram data of the video data by using the FPGA, after that, fuses the background image, the oscillogram data, and the video data into the video data carrying the vector diagram and outputs the video data with the oscillogram, thus providing an effective method for drawing a vector diagram of 8 k video data. The output video data with the oscillogram can be used by relevant personnel for analysis on the video image and other operations.

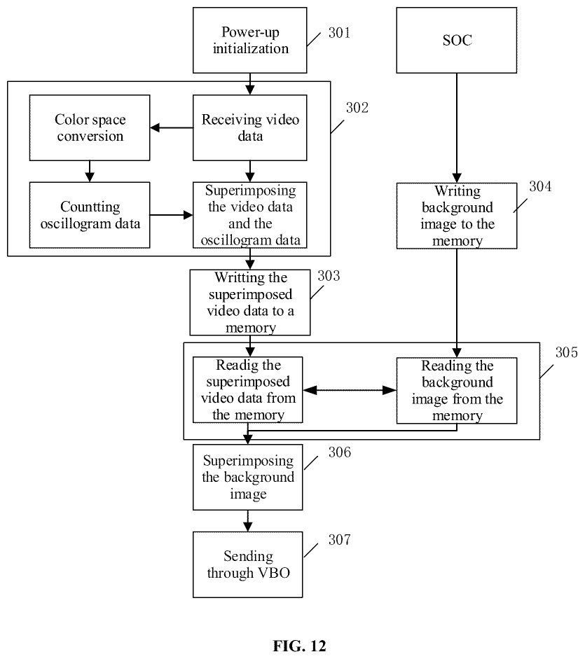

FIG. 12 is a schematic flowchart of a method for processing an image according to some embodiments of the present disclosure. As shown in FIG. 12, the method includes:

In step 301, an FPGA is powered up and initialized.

In step 302, the FPGA receives the video data, performs a color space conversion on the video data, counts the oscillogram data for each frame image in the video data, superimposes the video data and the oscillogram data, and obtains the superimposed video data.

In step 303, the superimposed video data is written to a memory.

In step 304, a background image is obtained from the SoC, and the background image is written to the memory.

It is noted that steps 302-303 as well as step 304 may be performed synchronously.

In step 305, the background image and the superimposed video data are read from the memory.

In step 306, video data with an oscillogram is obtained by fusing the superimposed video data with the background image.

In step 307, video data with an oscillogram is sent through the VBO interface.

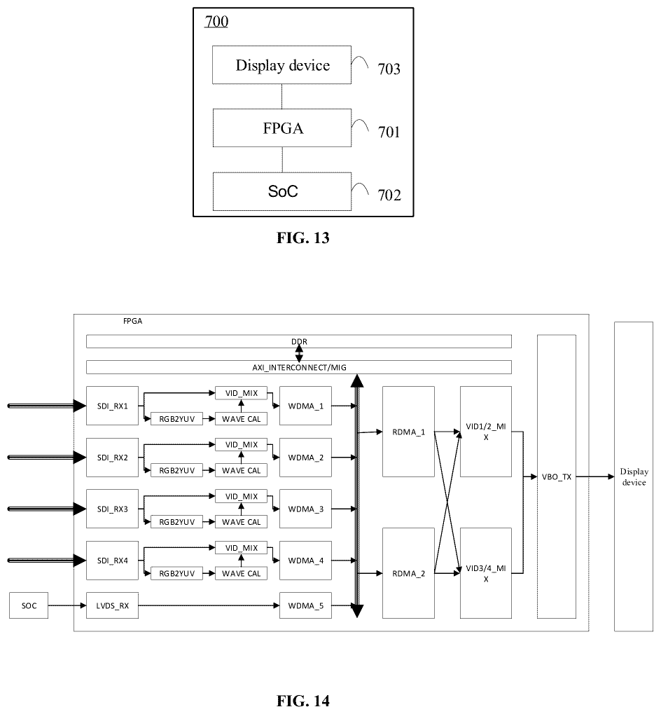

FIG. 13 is a schematic structural diagram of an apparatus for processing an image 700 according to some embodiments of the present disclosure. As shown in FIG. 13, the apparatus includes a field programmable gate array (FPGA) 701. The FPGA 701 is configured to acquire at least one channel of video data of an ultra-high-definition (UHD) video system; generate oscillogram data based on each channel of the video data; acquire a pre-generated background image of an oscillogram; and generate the oscillogram based on the background image and the oscillogram data.

Optionally, the FPGA 701 is configured to acquire at least one channel of superimposed video data by superimposing each channel of the video data with corresponding oscillogram data; and acquire at least one channel of video data with an oscillogram by fusing the at least one channel of superimposed video data with the background image.

Optionally, the FPGA 701 is configured to acquire at least two channels of video data of the UHD video system; and acquire at least two channels of video data with the oscillogram by fusing each channel of the superimposed video data with the background image.

Optionally, the FPGA 701 is configured to count oscillogram data of each frame image in each channel of the video data by regional counting. The way of regional counting is described in the previous method embodiments and will not be described in detail here.

Optionally, the FPGA 701 is configured to output the at least two channels of video data with the oscillogram; and the apparatus further includes a display device 703, the display device 703 is configured to display the at least two channels of video data with the oscillogram. wherein a display region of the display device 703 includes at least two subdisplay regions, each of the at least two subdisplay regions displaying one channel of video data with the oscillogram.

Optionally, the oscillogram data includes at least one of vector diagram data, histogram data, and waveform diagram data.

Optionally, the oscillogram includes a first oscillogram and a second oscillogram that are different types; and the background image includes a plurality of regions arranged in an array, each of the plurality of regions includes a first subregion and a second subregion, the first subregion of each of the plurality of regions is a background image of the first oscillogram, and the second subregion of each of the plurality of regions is a background image of the second oscillogram.

Optionally, the apparatus further includes a system on chip (SoC) 702 configured to generate the background image.

FIG. 14 is a schematic structural diagram of an apparatus for processing an image according to some embodiments of the present disclosure, showing the internal module structure of an FPGA. As shown in FIG. 14, the FPGA includes:
a plurality of serial digital interface (SDI) receiving module SDI_RX, each SDI_RX is configured to receive one channel of video data;
a plurality of conversion modules RGB2YUV, each RGB2YUV is configured to convert an image in RGB format to an image in YUV format in one channel of video data;
a plurality of data statistics modules WAVE CAL, each WAVE CAL is configured to generate oscillogram data of one channel of video data;
a plurality of superimposition modules VID_MIX, each VID_MIX is configured to superimpose each frame image in one channel of video data with corresponding oscillogram data to obtain corresponding superimposed video data;
one low-voltage differential signaling (LVDS) receiving module LVDS_RX configured to receive a background image of an oscillogram;
at least one image fusing module configured to fuse the background image and the superimposed video data into video data with an oscillogram. For example, there are two image fusing modules in FIG. 14, e.g. VID1/2_MIX and VID3/4_MIX. The image fusing module VID1/2_MIX is configured to fuse the video data superimposed on two channels of the two subdisplay regions (i.e., subdisplay region 1 and subdisplay region 2) of the first row in FIG. 11 and the corresponding background image, and the image fusing module VID3/4_MIX is configured to fuse the video data superimposed on two channels of the two subdisplay regions (i.e., subdisplay region 3 and subdisplay region 4) in the second row of FIG. 11 and the corresponding background image;
an outputting module VBO Tx configured to output the video data with the oscillogram;
a plurality of writing DDR controllers, including: a plurality of first write controllers (e.g., WDMA_1, WDMA_2, WDMA_3, and WDMA_4) and a second write controller (e.g., WDMA_5). Each of the first write controllers is configured to control the writing of one channel of superimposed video data, and the second write controller is configured to control the writing of the background image;
a plurality of reading DDR controllers, including: a first read controller RDMA1 configured to control reading of a plurality of channels of the superimposed video data; and a second read controller RDMA2 configured to control reading of the background image; and
an advanced extensible interface (AXI) interconnect module configured to connect the plurality of writing DDR controllers to the plurality of reading DDR controllers.

Optionally, as shown in FIG. 14, the apparatus further includes a DDR and a memory interface generator (MIG). The DDR is connected to the FPGA by the MIG, and is configured to store the superimposed video data and the background image, and the MIG is configured to read and write the DDR.

The DDR can be DDR3, or DDR4, or the like.

For the convenience of description, the above apparatus is divided into various modules by function for description. In addition, the functions of the various modules may be implemented in one or more software and/or hardware during the implementation of one or more embodiments of the description.

The apparatuses described in the foregoing embodiments are configured to implement the corresponding methods described in the aforementioned embodiments and have the beneficial effects of the corresponding method embodiments, which are not repeated herein.

The embodiments of the present disclosure provide a computer-readable storage medium storing a computer-executable instruction, and the computer-executable instruction can perform the method in any of the foregoing method embodiments. The technical effects of the embodiment of the computer-readable storage medium are the same as or similar to those of any of the foregoing method embodiments.

It should be noted that those of ordinary skill in the art can understand that all or part of the flows of the above method embodiments may be completed by a computer program to instruct related hardware, and the program may be stored in a computer-readable storage medium, which, when executed, may include the flows of the method embodiments as described above. The related hardware may include but is not limited to a CPU, a controller, and the like. The technical effects of the computer program embodiment are the same as or similar to any of the foregoing method embodiments.

In addition, typically, the apparatuses, devices, and the like described in the present disclosure may be various electronic terminal devices, such as a mobile phone, a personal digital assistant (PDA), a tablet computer (PAD), and a smart TV, and may also be large terminal devices, such as a server, thus the protection scope of the present disclosure should not be limited to a certain type of apparatus or device.

The computer-readable storage medium (for example, a memory) described herein may be a volatile memory or a non-volatile memory, or may include both the volatile memory and non-volatile memory. By way of exemplary but not limiting illustration, the non-volatile memory may be a read-only memory (ROM), a programmable ROM (PROM), an electrically programmable ROM (EPROM), an electrically erasable programmable ROM (EEPROM), or a flash memory. The volatile memory may be a random access memory (RAM), which is used as an external cache. By way of exemplary but not limiting illustration, many forms of RAMs, such as a synchronous RAM (DRAM), a dynamic RAM (DRAM), a synchronous DRAM (SDRAM), a double data rate SDRAM (DDR SDRAM), an enhanced SDRAM (ESDRAM), a synchronization link DRAM (SLDRAM), and a direct Rambus RAM (DRRAM), are available.

Those skilled in the art will also appreciate that the steps of the various exemplary logical blocks, modules, circuits, methods, and algorithms described in connection with the present disclosure herein may be implemented in the form of electronic hardware, computer software, or a combination thereof. For clarity of the interchangeability of the hardware and the software, various illustrative components, blocks, modules, circuits, and steps have been described generally in terms of their functions. Whether these functions are executed in the form of the hardware or software depends on the specific application and design constraints imposed on the overall system. Those skilled in the art can use different methods for implementing the described functions for each particular application, but such implementation should not be considered to be beyond the scope of the present invention.

The various exemplary logical blocks, modules, and circuits described in connection with the present disclosure herein may be implemented or executed by using the following components designed to perform the functions described herein: a general-purpose processor. a digital signal processor (DSP), an application specific integrated circuit (ASIC), a field programmable gate array (FPGA) or other programmable logic devices, discrete gate, or transistor logic, discrete hardware components, or any combination thereof. The general-purpose processor may be a microprocessor, but alternatively, the processor may be any conventional processor, controller, microcontroller, or state machine. The processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in a RAM, a flash memory, a ROM, an EPROM, an EEPROM, a register, a hard disk, a removable disk, a CD-ROM, or any other form of storage medium known in the art. An exemplary storage medium is coupled to the processor such that the processor can read information from, and write information to, the storage medium. In an alternative solution, the storage medium may be integrated with the processor. The processor and the storage medium may reside in an ASIC. The ASIC may reside in a user terminal. In an alternative solution, the processor and the storage medium may reside as discrete components in a user terminal.

In one or more exemplary designs, the functions described may be implemented in hardware, software, firmware, or any combination thereof. In the case that implemented in software, these functions may be stored on a computer-readable medium or transmitted by the computer-readable medium as one or more instructions or codes. The computer-readable medium includes a computer storage medium and a communication medium. The communication medium includes any medium that transfers a computer program from one place to another place. The storage medium may be any available medium accessible to a general-purpose or special-purpose computer. By way of exemplary but not limiting illustration, the computer-readable medium may include a RAM, a ROM, an EEPROM, a compact disc read-only memory (CD-ROM), or other optical disk storage devices, magnetic disk storage devices, or other magnetic storage devices, or any other medium that can be used to carry or store desired program codes in the form of instructions or data structures and are accessible to a general-purpose or special-purpose computer or a general-purpose or special-purpose processor. Moreover, any connection can be properly termed a computer-readable medium. For example, in the case that the software is transmitted from a website, server, or other remote sources using a coaxial cable, a fiber optic cable, a twisted pair, a digital subscriber line (DSL), or wireless technologies such as infrared, radio, and microwave, then the coaxial cable, the fiber optic cable, the twisted pair, the DSL, or the wireless technologies such as infrared, radio, and microwave are included in the definition of medium. The magnetic disks and optical disks, as used herein, include a compact disc (CD), a laser disc, an optical disc, a digital versatile disc (DVD), a floppy disk, and a Blu-ray disc where the magnetic disks usually reproduce data magnetically, while the optical disks reproduce data optically with lasers. Combinations of the above should also be included within the scope of computer-readable media.

A person of ordinary skill in the art should understand that the discussion of any of the above embodiments is merely for an exemplary purpose, and is not intended to imply that the scope of the present disclosure (including the claims) is limited to these examples. Under the concept of the embodiments of the present disclosure, the above embodiments or the technical features in different embodiments may also be combined. Moreover, many other variations in different aspects of the embodiments of the present disclosure as described above are possible but not provided in detail for the sake of brevity. Therefore, any omission, modification, equivalent substitution, improvement, and the like made within the spirit and principle of the embodiments of the present disclosure shall be construed as being included in the protection scope of the present disclosure.

1. A method for processing an image, applicable to a field programmable gate array (FPGA), comprising:
acquiring at least one channel of video data of an ultra-high-definition (UHD) video system;
generating oscillogram data based on each channel of the video data;
acquiring a pre-generated background image of an oscillogram; and
generating the oscillogram based on the background image and the oscillogram data.

2. The method according to claim 1, further comprising:
acquiring at least one channel of superimposed video data by superimposing each channel of the video data with corresponding oscillogram data; and
wherein said generating the oscillogram based on the background image and the oscillogram data comprises:
acquiring at least one channel of video data with an oscillogram by fusing the at least one channel of superimposed video data with the background image.

3. The method according to claim 2, wherein said acquiring at least one channel of video data of the UHD video system comprises:
acquiring at least two channels of video data of the UHD video system; and
said acquiring at least one channel of video data with the oscillogram by fusing the at least one channel of superimposed video data with the background image comprises:
acquiring at least two channels of video data with the oscillogram by fusing each channel of the superimposed video data with the background image.

4. The method according to claim 3, further comprising:
outputting the at least two channels of video data with the oscillogram, to cause a display device to display the at least two channels of video data with the oscillogram, wherein a display region of the display device comprises at least two subdisplay regions, each of the at least two subdisplay regions displaying one channel of video data with the oscillogram.

5. The method according to claim 1, wherein the oscillogram data comprises at least one of vector diagram data, histogram data, and waveform diagram data.

6. The method according to claim 1, wherein the oscillogram comprises a first oscillogram and a second oscillogram that are different types; and
the background image comprises a plurality of regions arranged in an array, each of the plurality of regions comprises a first subregion and a second subregion, the first subregion of each of the plurality of regions is a background image of the first oscillogram, and the second subregion of each of the plurality of regions is a background image of the second oscillogram.

7. The method according to claim 1, wherein the background image is pre-stored in a system on chip (SoC), and said acquiring the pre-generated background image of the oscillogram comprises:
receiving the background image from the SoC.

8. The method according to claim 1, wherein said generating oscillogram data based on each channel of the video data comprises:
counting oscillogram data of each frame image in each channel of the video data by regional counting.

9. The method according to claim 8, wherein said counting oscillogram data of each frame image in each channel of the video data by regional counting comprises:
regionally counting the oscillogram data of each frame image in each channel of the video data by using a dual-port random access memory (RAM) and a RAM ping-pong operation mechanism.

10. The method according to claim 9, wherein said regionally counting the oscillogram data of each frame image in each channel of the video data by using the dual-port RAM and the RAM ping-pong operation mechanism comprises:
determining, for each channel of the video data, a number of dual-port RAMs required according to a number of regions, wherein the number of dual-port RAMs required is twice the number of regions;
dividing the dual-port RAMs required into two groups; and
regionally counting the oscillogram data of each frame image in the video data by using the RAM ping-pong operation mechanism and two groups of dual-port RAMs, wherein one group of dual-port RAMs in the two groups of dual-port RAMs are configured to regionally count oscillogram data of an odd-numbered frame image in the video data, and the other group of dual-port RAMs in the two groups of dual-port RAMs are configured to regionally count oscillogram data of an even-numbered frame image in the video data.

11. The method according to claim 10, wherein said regionally counting the oscillogram data of each frame image in the video data by using the RAM ping-pong operation mechanism and the two groups of dual-port RAMs comprises the following two steps alternately:
regionally counting the oscillogram data of the odd-numbered frame image by using a first group of dual-port RAMs; and
regionally counting the oscillogram data of the even-numbered frame image by using a second group of dual-port RAMs;
wherein 0 is written into write ports of the second group of dual-port RAMs in response to write ports of the first group of dual-port RAMs regionally counting the oscillogram data of the odd-numbered frame image, and 0 is written into the write ports of the first group of dual-port RAMs in response to the write ports of the second group of dual-port RAMs regionally counting the oscillogram data of the even-numbered frame image; and
read ports of the second group of dual-port RAMs do not perform any operation in response to read ports of the first group of dual-port RAMs reading the oscillogram data of the odd-numbered frame image, and the read ports of the first group of dual-port RAMs do not perform any operation in response to the read ports of the second group of dual-port RAMs reading the oscillogram data of the even-numbered frame image.

12. The method according to claim 1, wherein the UHD video system is a 4 k-resolution video system, a 6 k-resolution video system, an 8 k-resolution video system, or a 12 k-resolution video system.

13. An apparatus for processing an image, comprising a field programmable gate array (FPGA), wherein the FPGA is configured to acquire at least one channel of video data of an ultra-high-definition (UHD) video system; generate oscillogram data based on each channel of the video data; acquire a pre-generated background image of an oscillogram; and generate the oscillogram based on the background image and the oscillogram data.

14. The apparatus according to claim 13, wherein the FPGA is configured to acquire at least one channel of superimposed video data by superimposing each channel of the video data with corresponding oscillogram data; and acquire at least one channel of video data with an oscillogram by fusing the at least one channel of superimposed video data with the background image.

15. The apparatus according to claim 14, wherein the FPGA is configured to acquire at least two channels of video data of the UHD video system; and acquire at least two channels of video data with the oscillogram by fusing each channel of the superimposed video data with the background image.

16. The apparatus according to claim 15, wherein the FPGA is configured to output the at least two channels of video data with the oscillogram; and
the apparatus further comprises a display device configured to display the at least two channels of video data with the oscillogram, wherein a display region of the display device comprises at least two subdisplay regions, each of the at least two subdisplay regions displaying one channel of video data with the oscillogram.

17. The apparatus according to claim 13, wherein the oscillogram data comprises at least one of vector diagram data, histogram data, and waveform diagram data.

18. The apparatus according to claim 13, wherein the oscillogram comprises a first oscillogram and a second oscillogram that are different types; and
the background image comprises a plurality of regions arranged in an array, each of the plurality of regions comprises a first subregion and a second subregion, the first subregion of each of the plurality of regions is a background image of the first oscillogram, and the second subregion of each of the plurality of regions is a background image of the second oscillogram.

19. The apparatus according to claim 13, further comprising a system on chip (SoC);
wherein the SOC is configured to generate the background image.

20. A non-transitory computer-readable storage medium storing a computer program, wherein the computer program, when executed by a processor, causes the processor to perform the method as defined in claim 1.
